(19) United States
(12) Patent Application Publication
(10) Pub. No.: US 2026/0016597 A1
(43) Pub. Date: Jan. 15, 2026

(54) DEVICE AND SYSTEM FOR LOCATING AN OBJECT

(71) Applicant: VALEO COMFORT AND DRIVING ASSISTANCE, Créteil (FR)

(72) Inventors: Ciprian Musat, Creteil (FR); Chloe Bonassi, Creteil (FR)

(73) Assignee: VALEO COMFORT AND DRIVING ASSISTANCE, Créteil (FR)

(21) Appl. No.: 18/993,753

(22) PCT Filed: Jul. 7, 2023
(86) PCT No.: PCT/EP2023/068944

§ 371 Date: Jan. 13, 2025

(30) Foreign Application Priority Data
Jul. 13, 2022 (FR) FR2207229

(51) Int. Cl. G01S 17/42; G01S 7/481; G01S 7/484

(52) U.S. Cl. CPC G01S 17/42; G01S 7/4815; G01S 7/484

(57) ABSTRACT

A device for locating an object includes at least two illumination modules and a computation unit. Each illumination module is arranged to emit an emitted beam. At least one detection circuit is arranged to receive at least two reflected beams. The computation unit is arranged to determine the position of the object by analysing the at least two reflected beams. Each beam emitted by one of the at least two illumination modules has a main light distribution obtained by combining at least two secondary light distributions. The device further including at least one optical component arranged to obscure part of the at least two secondary light distributions. One of the secondary light distributions is arranged to be superimposed at least in part on another of the secondary light distributions.

### TECHNICAL FIELD OF THE INVENTION

The present invention relates in general to a device for localizing an object.

It relates more particularly to a device for localizing an object positioned in a passenger compartment of a motor vehicle for controlling functions inside the passenger compartment, such as for example audio, air-conditioning, telephony, navigation, etc. functions.

It also relates to a system for localizing an object, preferably positioned in a passenger compartment of a vehicle.

### PRIOR ART

Object localization devices comprising at least two light modules positioned on the same axis, which illuminate an object and whose light reflected by said object is received by an optical receiver, are known. According to this arrangement, conventional triangulation methods are not applicable because the beams emitted by the light modules are aligned on the same axis. Therefore, in this configuration, it is feasible to derive positional information from the reflected beams based only on at least two light beams that each have spatially variable intensities as a function of the direction of emission.

Light modules that make it possible to obtain spatially variable intensities as a function of their direction of emission are usually obtained using specific light guides coupled to light sources. These light guides have complex shapes and therefore require high demands in terms of alignment with their light source and with the other elements present in the localization device. As a result, an alignment error penalizes the performance of the object localization device. Furthermore, these devices are complex to implement, this also causing problems in terms of the production cost of such a device.

### PRESENTATION OF THE INVENTION

In order to rectify the abovementioned disadvantages of the prior art, the present invention proposes a device for localizing an object, comprising:
at least two illumination modules, each illumination module being arranged so as to emit a beam, called emitted beam, in a direction of propagation;
at least one detection circuit arranged so as to receive at least two reflected beams, each reflected beam being associated with a reflection, from said object, of the beam emitted by one of the at least two illumination modules, said at least two illumination modules and said at least one detection circuit being positioned in the same plane, said device furthermore comprising:
a computing unit arranged so as to determine the position of said object by analyzing said at least two reflected beams, characterized in that each beam emitted by one of said at least two illumination
modules has a main light distribution obtained by combining at least two secondary light distributions, said device furthermore comprising at least one optical component arranged so as to mask a portion of said at least two secondary light distributions, one of said secondary light distributions being arranged so as to be superimposed at least partially on another of said secondary light distributions.

By virtue of the arrangement of the optical component and the secondary light distributions, it is possible easily to model the main distributions of the emitted beams. The device according to the present disclosure thus makes it possible easily to obtain emitted beams each having a spatially varying main distribution. Such a solution is easy to employ and to implement and inexpensive, since the device is made from standard components that are easier to arrange in the device according to the present disclosure. They also require fewer adjustments. As a result, the device according to the present disclosure is easier to modulate or modify.

Hereinafter, a light distribution is understood to mean the representation of the radiation pattern of the beam associated with this light distribution. This light distribution may be represented either by its associated spatial distribution or by its associated angular distribution.

In the present disclosure, a total angular extent is understood to mean the total angular aperture or the total angular range of the angular distribution of the light distribution.

In the present disclosure, the intensity emitted by a light source varies with the direction of emission. Each light source preferably has a total angular extent exhibiting symmetry about its optical axis. Preferably, each total angular extent has a maximum point positioned on the optical axis of the light source.

The total angular extent or total angular aperture defines a half-angle. In the present disclosure, the half-angle corresponds to half the total angular extent or total angular aperture. It is thus possible to define an illumination limit, a curve or the intensity of the light is reduced by half at the half-angle. Thus, at the half-angle, the emission intensity of the light source emitted at this angle is half the intensity emitted at the center, that is to say half the intensity emitted along the optical axis of the light source.

Other advantageous and non-limiting features of the device according to the invention, taken individually or in any technically feasible combination, are set out below.

According to one advantageous embodiment, the main light distribution emitted by one of said at least two illumination modules is arranged so as to illuminate, in a vertical direction, at least partially the same area of space as the at least one other main light distribution emitted by the at least one other of said at least two illumination modules so as to localize the object along a vertical direction of the plane.

According to this last embodiment, each secondary distribution of one of said at least two illumination modules is arranged so as to illuminate, in a vertical direction, at least partially the same area of space as at least one of said at least two secondary distributions of at least one other of said at least two illumination modules.

According to another advantageous embodiment, the device according to the present disclosure comprises at least two other illumination modules positioned on said plane, said at least one detection circuit being positioned between said at least two illumination modules and said at least two other illumination modules, the main light distribution emitted by one of said at least two illumination modules is arranged so as to illuminate, in a horizontal direction, at least partially the same area of space as the at least one main light distribution emitted by the at least one other of said at least two other illumination modules, so as to be able to localize the object along a horizontal direction of the plane in order to obtain the position of said object in three dimensions.

According to one advantageous embodiment of the present disclosure, each illumination module comprises at least two distinct light sources each emitting an initial beam having one of said secondary light distributions.

In one embodiment, said at least two light sources are aligned along a main axis that is parallel or orthogonal to an axis of said plane.

According to another embodiment of the invention, each illumination module comprises a light source arranged so as to emit an initial beam in a light guide, said light guide being arranged so as to emit said at least two secondary light distributions.

In another embodiment, each main light distribution has a maximum point relative to a maximum light intensity, each maximum point of the main light distributions being angularly separated by at least ten degrees from the other maximum points of the other main light distributions in a vertical direction.

In one embodiment, each illumination module comprises an optical axis, the optical axis of said at least two illumination modules being inclined with respect to one another at an angle of between 10 and 90 degrees.

In one embodiment, each secondary light distribution comprises an angular distribution distinct from the angular distribution of the at least one other of said secondary light distributions of the same illumination module.

In one embodiment, each main light distribution has a total angular extent of between 10 and 90 degrees, preferably between 20 and 60 degrees.

In one embodiment, each secondary light distribution has a total angular extent of between 20 and 150 degrees, preferably between 50 and 120 degrees.

In another embodiment, in the same illumination module, at least one of said secondary angular distributions has a total angular extent of between 20 and 60 degrees, preferably between 30 and 50 degrees, while the at least one other of said at least two secondary angular distributions has a total angular extent of between 45 and 150 degrees, preferably between 70 and 120 degrees.

In other words, in this embodiment, in the same illumination module, at least one of said secondary angular distributions has a total angular extent with a half-angle of between 20 and 45 degrees, preferably between 20 and 25 degrees, while the at least one other of said at least two secondary angular distributions has a total angular extent with a half-angle of between 40 and 80 degrees, preferably between 50 and 70 degrees.

In one embodiment, said at least one optical component is arranged so as to mask at least half of said at least two secondary light distributions of the same illumination module.

In one embodiment, the at least one optical component is an absorbing element or an optical-beam deflecting element.

In one embodiment, said at least two illumination modules are arranged on either side of said at least one optical component.

In one embodiment, the emitted beam is an infrared beam.

In another embodiment, the beam emitted by each illumination module is a pulsed beam.

In one embodiment, said pulsed beam contains at least one pulse of at least ten microseconds.

In one embodiment, said device furthermore comprises a control circuit configured to activate the at least two illumination modules alternately.

In one embodiment, said at least two illumination modules are arranged symmetrically with respect to an axis of said plane.

In one embodiment, the position of said object is determined as a function of a chart linking a ratio between an intensity of one of said at least two reflected beams and an intensity of another of said at least two reflected beams.

The invention also proposes a system comprising:
a device according to the present disclosure,
a display screen arranged so as to extend in two directions, respectively called main vertical direction and main horizontal direction, said at least two illumination modules and said at least one detection circuit being aligned along said main horizontal direction.

Of course, the various features, variants and embodiments of the invention may be associated with one another in various combinations provided that they are not mutually exclusive or incompatible.

### DETAILED DESCRIPTION OF THE INVENTION

The description that follows with reference to the appended drawings, which are given by way of non-limiting examples, will give a good understanding of the content of the invention and how it may be implemented.

In the appended drawings:

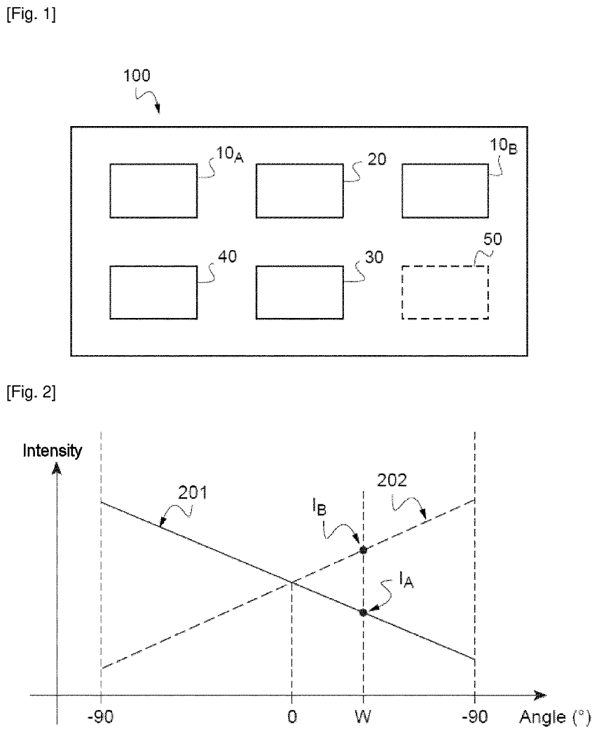

FIG. 1 is a schematic depiction of one exemplary embodiment of a device according to the invention;

FIG. 2 is a schematic depiction of a chart for finding an angular position of an object as a function of variations in intensity of two reflected beams coming from each illumination module of the device of FIG. 1;

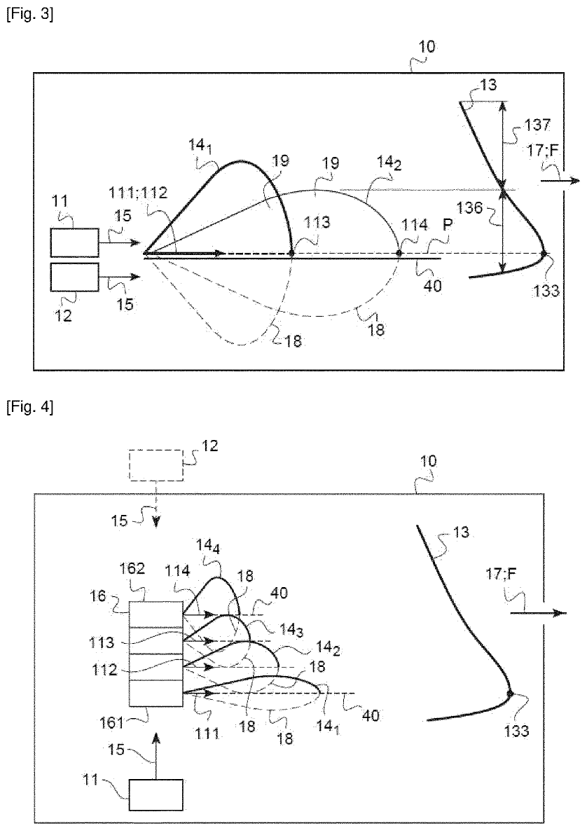

FIG. 3 is a schematic depiction of a first embodiment of an illumination module used in the device according to the present disclosure;

FIG. 4 is a schematic depiction of a second embodiment of an illumination module used in the device according to the present disclosure;

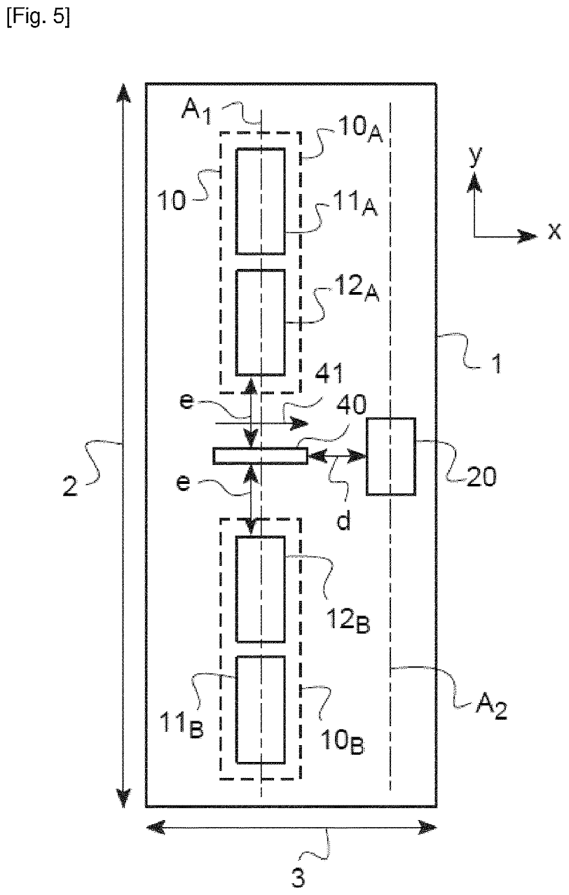

FIG. 5 is a first embodiment of an arrangement of two illumination modules and a detection circuit in a device according to the present disclosure;

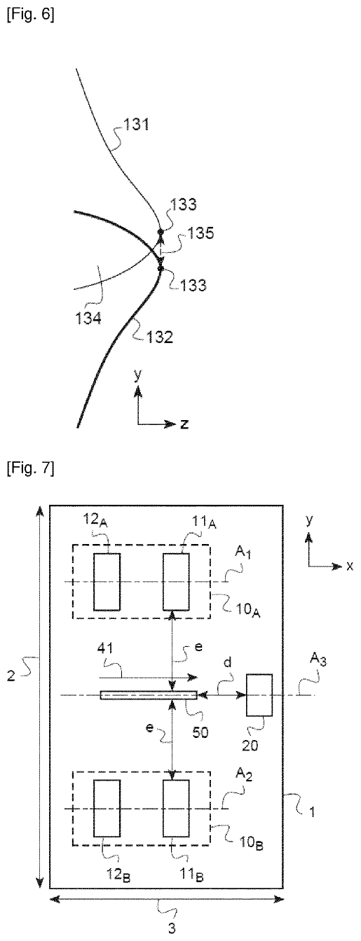

FIG. 6 is a schematic depiction of two main light distributions obtained using the arrangement illustrated in FIG. 5;

FIG. 7 is a second embodiment of an arrangement of two illumination modules and a detection circuit in a device according to the present disclosure;

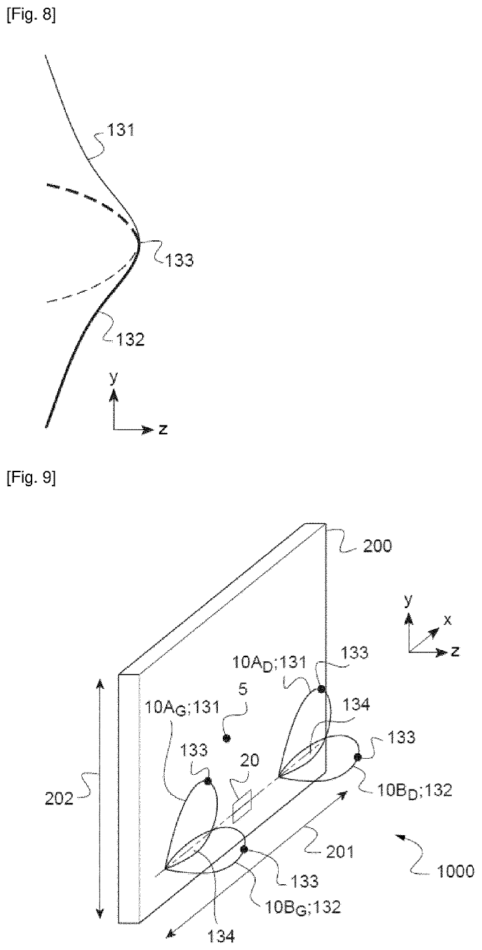

FIG. 8 is a schematic depiction of two main light distributions obtained using the arrangement illustrated in FIG. 7;

FIG. 9 is a perspective view of one embodiment of a system according to the present disclosure;

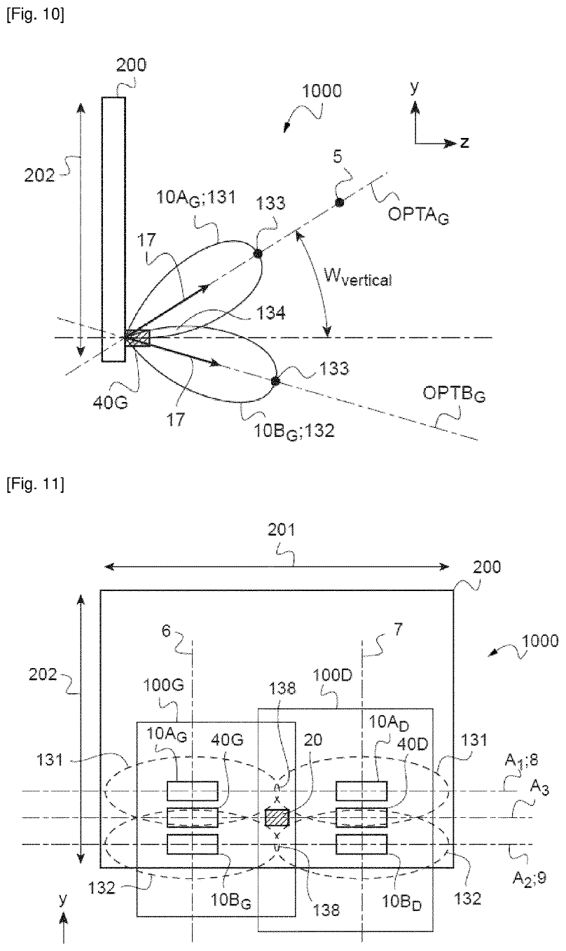

FIG. 10 is a profile view of the first embodiment of the system according to the present disclosure;

FIG. 11 is a front view of the first embodiment of the system according to the present disclosure.

### DEVICE

A first embodiment of a device 100 for localizing an object 5 according to the present disclosure will be described with reference to FIGS. 1, 2, 3, 5 and 6. By way of example, the object may be associated with a hand of an individual positioned facing the device 100.

The device 100 illustrated in FIG. 1 comprises, in this example, two illumination modules 10, respectively denoted 10A, 10B, a detection circuit 20, a computing unit 30 and an optical component 40. Advantageously, the computing unit 30 of the device 100 may be a computer, a processor or any other electronic element for implementing a succession of commands and/or computations.

In the device 100, each illumination module 10 is arranged so as to emit a beam, called emitted beam F, in a direction of propagation 17. The detection circuit 20 is arranged so as to receive two reflected beams. Each reflected beam is associated with a reflection, from said object 5, of the beam F emitted by one of the two illumination modules 10. Therefore, each reflected beam is associated with an illumination module 10.

The computing unit 30 is arranged so as to determine the position of the object 5 by analyzing the two reflected beams.

According to this example, each beam F emitted by the two illumination modules 10 has a main light distribution 13 obtained by combining at least two secondary light distributions 14. The device 100 furthermore comprises an optical component 40 arranged so as to mask a portion of said at least two secondary light distributions, one of said secondary light distributions 14₁ being arranged so as to be superimposed at least partially on another of said secondary light distributions 14₂.

FIG. 3 illustrates a first exemplary embodiment of the illumination module 10 of the device 100 emitting an emitted beam F. The illumination module 10 illustrated in FIG. 3 comprises at least two distinct light sources 11, 12.

The two light sources 11, 12 illustrated in FIG. 3 are each arranged so as to emit an initial beam 15. Each initial beam 15 emitted by the light sources 11, 12 has a secondary light distribution 14. By way of example, the secondary light distribution 14₁ is emitted by the light source 11, while the light distribution 14₂ is emitted by the light source 12. The two secondary light distributions 14₁ and 14₂ are superimposed (here along a secondary area of overlap 19), thus creating the main light distribution 13 by combining the two secondary light distributions 14₁, 14₂.

According to this example, the properties of the emitted flux F therefore depend on the initial beams 15 emitted by the two light sources 11, 12. Consequently, the main light distribution 13 is a function of the properties of the secondary light distributions 14₁, 14₂, in particular of the properties of the secondary light distributions in the secondary area of overlap 19. By way of example, properties of the secondary light distributions are understood to mean at least one of the features listed below:
the shape of the secondary light distribution,
its spread, defined by a total angular extent or its total angular aperture,
its variation in spatial intensity,
its variation in angular intensity,
its spectrum,
the wavelength associated with the initial beam 15 of the secondary light distribution, etc.

Such an arrangement makes it possible easily to model the emitted beam F and the main light distribution 13 associated with this emitted beam F. Therefore, the illumination module 10 of FIG. 3 consists of standard components and is easy to implement and inexpensive. Furthermore, these components require few adjustments or adjustments that are very easy to implement compared to using a light module consisting of complex light guides.

According to the example illustrated in FIG. 3, the two secondary distributions 14₁, 14₂ of the initial beam 15 emitted by the two light sources 11, 12 each have a secondary direction of propagation 111, 112. The secondary directions of propagation 111, 112 are aligned on the same axis P to within 0.3 millimeters and are parallel to the direction of propagation 17 of the emitted beam F. In this example, the secondary light distributions 14₁, 14₂ each have a secondary maximum point 113, 114 that is relative to a maximum intensity of the secondary light distribution 14₁, 14₂ with which it is associated.

In the example of FIG. 3, these secondary maximum points 113, 114 are aligned on the same axis, here the axis P. Therefore, the maximum point 113 has an angular position on its associated secondary light distribution 14₁ that is equivalent to the angular position of the maximum point 114 associated with the secondary light distribution 14₂. Such an arrangement makes it possible to obtain a main distribution 13 with a single maximum intensity point 133.

In this example, the optical component 40 is positioned in the illumination module 10 illustrated in FIG. 3. Preferably, it is arranged so as to mask a portion 18 of the secondary light distributions 14₁, 14₂. The optical component 40 is thus positioned so as to cut off a portion of the secondary light distributions 14₁, 14₂, in particular a portion positioned after the secondary maximum point 113, 114 of each secondary light distribution 14₁, 14₂. Therefore, for each initial beam 15, only the portion of the secondary distribution 14₁ or 14₂ oriented on the side not masked by the optical component 40 (that is to say on the other side of the maximum point 113, 114) is retained. The use of such an optical component 40 makes it possible easily and inexpensively to select the portions of the secondary light distributions 14₁, 14₂ that will form the main light distribution 13. In one preferred embodiment, the optical component 40 is an absorbing element arranged so as to absorb a portion of the two secondary distributions 14₁, 14₂. In another embodiment, the optical component 40 may be an optical-beam deflecting element. Preferably, the optical component 40 is arranged so as to mask half of the two secondary light distributions 14₁, 14₂. Such an arrangement improves the simplicity of the function of selecting the optical component 40 explained above even further.

The two secondary light distributions 14₁, 14₂ each have their own total angular extent or total angular aperture. Optionally, the secondary light distribution 14₁ has an angular distribution different from the angular distribution of the secondary light distribution 14₂. Therefore, the variation of the secondary light distributions 14₁, 14₂ is different. According to this example, the secondary light distribution 14₁ has a total angular extent smaller than a total angular extent of the secondary light distribution 14₂. By way of example, the total angular extent of the secondary light distribution 14₁ is 50.0 degrees (°), while the total angular extent of the secondary light distribution 14₂ is 120.0 degrees. Thus, according to this example, the half-angle of the secondary light distribution 14₁ is 25.0 degrees, while the half-angle of the secondary light distribution 14₂ is 60.0 degrees.

Such a configuration makes it possible to obtain a main distribution 13 having an angular extent that depends on the angular extent of the two secondary light distributions 14₁, 14₂.

The total angular extent of the main light distribution 13 is obtained from the non-masked portions of the secondary light distributions 14₁, 14₂. This thus makes it possible to obtain a main light distribution 13 with a wide angular extent and that exhibits high intensities over a first angular range 136 that is substantially proportional to the secondary light distribution 14₁, and lower intensities over a second angular range 137 that is proportional to the secondary light distribution 14₂. In this example, the first angular range 136 is smaller than the second angular range 137, thereby making it possible to obtain an emitted beam F with a directional portion and high intensity over the first angular range 136 and a less directional portion over the second angular range 137 and exhibiting lower intensities compared to the intensities of the main light distribution 13 over the first angular range 136. By way of example, the total angular extent of the main light distribution 13 shown in FIG. 3 is of the order of 60 degrees to within 10 degrees, that is to say of the order of the half-angle of the secondary light distribution 14₂ (of larger total angular extent).

Such features make it possible easily and inexpensively to obtain a wide and spatially varying main light distribution 13. The variation of the main light distribution may be modeled easily (by acting on the total angular extents or half- angles of the total angular extents of the secondary light distributions 14₁, 14₂) so as to obtain a good signal-to-noise ratio in desired detection areas.

The two light sources 11, 12 are preferably light-emitting diodes emitting in the infrared, preferably in the near-infrared between 780 nanometers and 1400 nanometers. The emitted beam F thereby does not disturb the vision of an individual in a vehicle. In the example under consideration, the two light sources 11, 12 emit at the same wavelength of 890 nanometers. Optionally, the two light sources 11, 12 are pulsed sources emitting pulses of at least 10 microseconds, preferably of 10 microseconds. The beam F emitted by the illumination module 10 of FIG. 3 is thus a pulsed beam that contains pulses that depend on the pulses from the two light sources 11, 12. Preferably, the emitted beam F from the illumination module 10 illustrated in FIG. 3 contains pulses of at least ten microseconds, preferably equal to 10 microseconds. Such an arrangement makes it possible to facilitate processing and analysis of the reflected beams so as to find the position information regarding said object 5.

FIG. 4 illustrates a second exemplary embodiment of an illumination module 10 of the device 100. Only the differences in relation to FIG. 3 will be described. According to this example, the illumination module 10 comprises a single

light source 11 and a light guide 16. The light source 11 illustrated in FIG. 4 is arranged so as to emit an initial beam 15 in the light guide 16, in particular at a first end 161 of the light guide 16. The light guide 16 is arranged so as to emit multiple secondary distributions 14. In the example illustrated, at least four secondary distributions, numbered 14₁, 14₂, 14₃, 14₄, are formed from the light guide 16. Each secondary distribution 14 in the example illustrated in FIG. 4 is arranged so as to propagate in a secondary direction of propagation, respectively numbered 111, 112, 113, 114. According to the example of FIG. 4, each secondary distribution 14 is arranged so as to be superimposed with its adjacent secondary distributions.

Combining four secondary light distributions 14 makes it possible to sample a detection area more finely. Measurement accuracy is therefore increased. Such accuracy may be obtained with the illumination module in the example illustrated in FIG. 3 by increasing the number of light sources 11, 12. These additional light sources may also have distinct angular extents or distinct total angular aperture half-angles.

In the examples of FIGS. 3 and 4, the combination of the main light distributions 13 of each illumination module 10A, 10B defines the detection area associated with the device 100. By way of example, the detection area is defined as a function of the total angular extent of each main light distribution 13 of the device 100 for an object-detection circuit 20 distance that varies between 1.0 centimeters and 30.0 centimeters. According to this example, the detection area is defined along a horizontal direction 3 of the plane 1 and along a vertical direction 2 of the plane 1.

According to the example of FIG. 4, the device 100 comprises a plurality of optical elements 40 that are incorporated in the light guide 16. There are as many secondary light distributions 14 as there are optical elements 40. Each optical element 40 is thus associated with a secondary light distribution 14 in order to mask a portion 18 of this secondary light distribution 14. Here, half of each secondary distribution 14 is masked by the optical component 40. Such an arrangement makes it possible easily to modulate the main light distribution 13.

In the example of FIG. 4, the secondary light distributions 14 have a total angular extent with a half-angle that is arranged so as to increase as a function of the propagation of the initial beam 15 in the light guide 16. Such an arrangement makes it possible to obtain a main light distribution 13 that has a variation in luminous intensity (or intensity profile) that varies progressively as a function of an angle of emission associated with the main light distribution 13. Such a guide is easier to implement and to adjust.

Unlike in FIG. 3, using a light guide 16 that emits secondary light distributions 14 as illustrated in FIG. 4 may cause manufacturing difficulties compared to a light module 10 as illustrated in FIG. 3. Furthermore, the light guide 16 is fixed after manufacture. The illumination module of FIG. 4 is therefore not able to be modulated as much as in the example illustrated in FIG. 3, in which the optical component 40 may have a modulable position.

Preferably, the two illumination modules 10 of the device 100 illustrated in FIG. 1 are similar. This makes it possible to obtain two main light distributions 13 that are similar, thus making it possible to guarantee that the device 100 is of simple design. The device 100 may thus comprise two light modules 10, as illustrated in the example of FIG. 3. In the case of the example of FIG. 4, another light source 12 arranged so as to emit another initial beam 15 at the second end 162 of the light guide 16 makes it possible to obtain a second illumination module 10 used in the device 100. Such an arrangement avoids the use of a second light guide 16, thereby also avoiding additional adjustments that may be tedious.

In another embodiment, the other light module 10 may comprise the same elements illustrated in FIG. 4. In this case, the light guide 16 of each illumination module 10 may be superimposed, each light guide 16 being arranged so as to form a main light distribution 13 that is inverted with respect to the other light guide belonging to the other illumination module 10.

FIG. 6 illustrates one example of two main distributions 13, numbered 131, 132, obtained by the device 100 illustrated in FIG. 1 by way of two illumination modules 10, which are illustrated according to the example of FIG. 3 or 4. The main distributions 131, 132 that are obtained are oriented along the vertical direction 2 of the plane 1 (that is to say along the y-axis).

According to the example of FIG. 6, the two main light distributions 131, 132 exhibit a similar variation (in intensity). They both exhibit a spatially varying variation in intensity. However, the two main light distributions 131, 132 are inverted with respect to one another. Furthermore, the two main light distributions 131, 132 are superimposed on an overlapping portion, denoted 134. The illumination modules 10A and 10B are thus arranged so as to illuminate, preferably separately, the same area of space, defined in this example by the area of overlap 134. Such an arrangement makes it possible to sample the detection area continuously. The area of overlap 134 is oriented, in this example, in a vertical direction 2.

According to this example, the two main light distributions 131, 132 each have a maximum point 133. The two maximum points 133 illustrated in FIG. 6 are angularly separated (distance 135 in FIG. 6) by at least ten degrees along the vertical direction 2, making it possible easily to associate each reflected beam with an illumination module 10 in order to determine the position of said object 5 in the vertical direction 2 (that is to say along the vertical y-axis).

Preferably, the two illumination modules 10 of the device 100 are configured to emit their emitted beam F alternately. Therefore, the two main light distributions 131, 132 will be emitted alternately, making it easier to associate the received reflected beam with the beam F emitted by the illumination module 10 in order to find the position of the object 5. Such features improve the ease of implementation of the device 100 even further.

Furthermore, since the two secondary light distributions 131, 132 are arranged so as to (alternately) illuminate the same area of space, that is to say the overlapping portion 134, it is not necessary to use a linearization function linking the intensity of the reflected beam associated with the emitted beam F from the module 10A with the intensity of the received beam associated with the emitted beam F at the module 10B. The processing carried out by the computing unit 30 is therefore easier to implement and less expensive in terms of computing time. Preferably, when the two illumination modules 10A, 10B are activated alternately, the arrangement 100 illustrated in FIG. 1 optionally comprises a control circuit 50 configured to activate the two illumination modules 10A, 10B alternately.

Thus, according to the present disclosure, by analyzing the proportion of light coming from the illumination module 10A and the proportion of light coming from the illumination module 10B, it is possible to localize an object 5 in the vertical direction 2 of the plane (that is to say along the vertical y-axis).

FIG. 2 illustrates one example of a chart that makes it possible to find the position of the object 5 in the vertical direction 2 based on the reflected beams coming from the main light distributions 131, 132 of each illumination module 10A and 10B illustrated in FIG. 6. The chart as illustrated in FIG. 2 is prerecorded, for example in an external memory linked to the device 100 or an internal memory of the computing unit 30. According to one example, this chart was recorded using a target associated with an object 5 to be detected having a grey of 18% (reflectance of 10%). The target was moved in space (that is to say in the detection area, in particular along the vertical direction 2 for various positions along a horizontal x-axis of the plane 1) at a distance from the detection circuit 20 varying between 5 mm for two-dimensional detection along the vertical y-axis (vertical direction 2 of the plane 1) and 150 mm when three-dimensional detection is carried out (FIGS. 9, 10 and 11). The beams reflected by the target were recorded. In this example, the zero angular position w is associated with an object 5 positioned facing the detection circuit 20 (along its optical axis), the variation in intensity of the beam reflected by the illumination module 10A is associated with the variation denoted 201, while the variation in intensity of the beam reflected by the illumination module 10B is associated with the variation denoted 202.

Using FIG. 2, the position of the object 5 is found as follows. The illumination modules 10A and 10B of the device 100 emit their emitted beam F alternately, each reflected beam of intensity IA or IB received by the detection circuit 20 is associated with an illumination module 10A or 10B of the device 100, and therefore with the variation in intensity 201 or 202. The intensity value of each reflected beam I_{A} and I_{B} received by the detection circuit 20 may thus be associated with the angular position w_{vertical} using a conversion table. For example, the following ratio R_{vertical} makes it possible to find the angular position with the prerecorded conversion table, which associates, with each ratio value R_{vertical}, an angular position or an angle w_{vertical}:

$${R}_{vertical} = \frac{{I}_{A}}{{I}_{B}} \qquad [ Math 1 ]$$

Furthermore, the addition of the intensity associated with the reflected beam I_{A} from the light module 10A with the intensity associated with the reflected beam I_{B} from the light module 10B makes it possible to estimate the distance T between the object 5 and the detection circuit 20. The distance T between the object 5 and the detection circuit 20 is thus determined using the following formula:

$$T = {I}_{A} + {I}_{B} \qquad [ Math 2 ]$$

Thus, according to this embodiment, the position of said object 5 is determined, in polar coordinates, by the angle w_{vertical} and the distance between the object 5 and the detection circuit 20. It is therefore possible, using the angle w_{vertical} and the distance T between the object 5 and the detection circuit 20, to find the two-dimensional Cartesian coordinates in the vertical direction 2 of the plane 1 (vertical y-axis) using conventional trigonometric formulas.

The three-dimensional position of the object may be obtained using a device according to the present disclosure comprising two other illumination modules 10 positioned on said plane 1. In this embodiment, the detection circuit 20 is positioned between the two illumination modules 10 and the other two illumination modules 10 (FIGS. 9-10). According to this embodiment, the main light distribution 13 emitted by one of said two illumination modules 10 is arranged so as to illuminate, in a horizontal direction 2, at least partially the same area of space as the at least one other main light distribution 13 emitted by one of the other two illumination modules 10.

FIG. 5 illustrates a first exemplary arrangement of two illumination modules 10, respectively denoted 10A and 10B, with a detection circuit 20 and an optical component 40 in the device 100.

According to this example, the illumination modules 10A, 10B and the detection circuit 20 are positioned in the same plane 1. The plane 1 is arranged so as to extend in the vertical direction 2 and the horizontal direction 3. The optical component 40 is positioned between the two illumination modules 10A and 10B and extends along a direction of elongation 41 that is orthogonal to the vertical direction 2 of the plane 1. In this embodiment, the illumination modules 10A, 10B and the optical component 40 are aligned along a first main axis, denoted A1, while the detection circuit 20 is aligned along a second main axis, denoted A2, which is parallel to the first main axis A1. The first main axis A1 and the second main axis A2 are parallel to the vertical direction 2. The optical component 40 is positioned at a distance d from the detection circuit 20. The distance d separating the optical component 40 from the detection circuit 20 is less than 10 millimeters, preferably less than 5 millimeters. Furthermore, in the example of FIG. 5, the optical component 40 is positioned equidistantly between the illumination modules 10A, 10B. By way of example, the optical component 40 is positioned at a distance e from the illumination modules 10A and 10B that is given for example by the distance between the light source 12A or 12B and a wall of the optical component 40 oriented on the side of the illumination module 10A or 10B. The distance e is preferably less than 3 millimeters.

In this example, each illumination module 10A, 10B comprises the two light sources 11, 12, numbered 11A and 12A for the light sources of the illumination module 10A and 11B and 12B for the light sources of the illumination module 10B. Preferably, the illumination modules 10A and 10B are similar to the illumination module 10 illustrated in FIG. 3. Thus, by way of example, the light sources 11A and 11B each have a total angular extent (that is to say total angular aperture) of 120.0 degrees (that is to say a half-angle of 60.0 degrees), while the light sources 12A and 12B each have a total angular aperture of 50.0 degrees (that is to say a half-angle of 25.0 degrees). Therefore, according to this embodiment, the light sources 11A and 11B (that is to say light source having the highest total angular extent) are further from the optical component 40 than the light sources 12A and 12B.

Positioning the light sources 11A and 11B having the highest total angular extents at a distance further from the optical component 40 makes it possible to avoid sharp cutoffs in the main light distribution 13 emitted by each of the illumination modules 10A, 10B. Furthermore, such an arrangement is more favorable for axial integration of the elements of the device 100 in a dashboard of a vehicle.

FIG. 7 illustrates a second exemplary arrangement of two illumination modules 10 with a detection circuit 20 and an optical component 40 in the device 100. Only the differences in relation to FIG. 5 will be described.

In this embodiment, the illumination module 10A is oriented along a first main axis denoted A1 and the illumination module 10B is oriented along a second main axis denoted A2. The optical component 40 and the detection circuit 20 are aligned along a third main axis A3. The first, second and third main axes A1, A2, A3 are parallel to one another and parallel to the direction of elongation 2 (vertical direction) of the plane 1, the third main axis A3 being positioned between the first and second main axes A1, A2. Therefore, in this arrangement, the illumination modules 10A, 10B are positioned symmetrically with respect to the third main axis A3.

In this embodiment, each light source 11A, 11B and 12A, 12B is separated from the optical component 40 by the distance e, this meaning that the light sources 11A and 11B, 12A and 12B in the example of FIG. 7 are not far from the optical component 40 as a function of their total angular extent or half-angle, unlike the example illustrated in FIG. 5.

FIG. 8 illustrates one example of two main distributions 13, numbered 131, 132, obtained by the device 100 illustrated in FIG. 1 by way of the arrangement illustrated in FIG. 7. Only the differences in relation to FIG. 6 will be described. According to this example, the maximum points 133 of the two main distributions 131, 132 are superimposed. This makes it possible to obtain sampling that is more continuous than the example illustrated in FIG. 6. Furthermore, this makes it possible to obtain a continuous variation in intensity related to the main distributions 131, 132. The main distributions 131, 132 are therefore directional in the same detection area. However, the processing of the reflected beams carried out by the computing unit 30 may be more tedious and less accurate than that in the example of FIG. 6. System

FIGS. 9, 10 and 11 illustrate one example of a system 1000 according to the present disclosure. The system 1000 illustrated in FIGS. 9, 10 and 11 comprises a display screen 200 and two devices, respectively denoted 100G and 100D.

The display screen 200 is arranged so as to extend in two directions of elongation 201, 202, respectively called main horizontal direction 201 and main vertical direction 202.

In another variant, the display screen 200 may be inclined by an angle of inclination that is obtained by rotating the display screen 200 about an axis parallel to the first main axis A1 or parallel to the main horizontal direction 201. The angle of inclination is preferably less than 50 degrees.

According to this example, the two devices 100_{G} and 100_{D} are identical and comprise a common detection circuit 20. The device 100_{G} positioned to the left of the detection circuit 20 comprises two illumination modules 10A_{G} and 10B_{G} separated by the optical element 40_{G}, and the device 100_{D} positioned to the right of the detection circuit 20 comprises two illumination modules 10A_{D} and 10B_{D} separated by the optical element 40_{D}. The arrangement of the two illumination modules 10A_{G}, 10A_{D}, 10B_{G}, 10B_{D} and of the optical element 40_{G} and 40_{D} of each device 100_{G} and 100_{D} may be similar to those shown in FIGS. 5 and 7.

According to this example, the two devices 100_{G} and 100_{D} are identical. They each consist of two illumination modules 10A, 10B. The illumination modules 10A_{G} and 10A_{D} comprise the light sources 11A and 12A, and the illumination modules 10B_{G} and 10B_{D} comprise the light sources 11B and 12B. As before, the light sources 12A and 12B each have a smaller total angular aperture than the light sources 11A and 11B.

In this example, the illumination modules 10A_{G} and 10A_{D} are aligned on the first main axis A1, which is parallel to the main horizontal direction 201 of the display screen 200, and the illumination modules 10B_{G} and 10B_{D} are aligned on the second main axis A2, which is parallel to the main horizontal direction 201 of the display screen 200. Therefore, in the system 1000, the plane 1 of each device 100_{G} and 100_{D} is a plane of the display screen 200. The optical elements 40_{G} and 40_{D} of each device 100_{G} and 100_{D} and the detection circuit 20 are aligned on the third main axis A3, which is parallel to the main horizontal direction 201 of the display screen 200. Preferably, the detection circuit 20 is positioned equidistantly from the optical components 40_{G} and 40_{D}. In this embodiment, the distance d separating the detection circuit 20 from each optical component 40_{G} and 40_{D} preferably varies between 20.0 millimeters and 300.0 millimeters.

FIG. 9 illustrates a profile view of the system 1000. According to this depiction, the illumination module 10A_{G} comprises an optical axis OPTA_{G} relative to a direction of illumination of the illumination module 10A_{G}. The optical axis may be defined as an axis passing through one of the light sources 11A, 12A and passing through the maximum 133 of the main distribution 131. The optical axis OPTA_{G} is parallel to the direction of propagation 17 of the beam F emitted by the illumination module 10A_{G}. The illumination module 10B_{G} comprises an optical axis OPTB_{G} relative to a direction of illumination of the illumination module 10B_{G} and defined similarly to the optical axis OPTA_{G} of the illumination module 10A_{G}. The optical axis OPTB_{G} is parallel to the direction of propagation 17 of the beam F emitted by the illumination module 10B_{G}.

In this example, the optical axis OPTA_{G}, OPTB_{G} of the two illumination modules 10A_{G} and 10B_{G} are inclined with respect to one another at an angle of between 10 and 90 degrees, an angle given between their respective maximum intensity point 133. In this way, the illumination module 10A_{G} is arranged so as to illuminate an area of space 8 (shown schematically on the first main axis A1), called upper area 8, of the detection area, while the illumination module 10B_{G} is arranged so as to illuminate another area of space 9 (shown schematically on the second main axis A2), called the lower area 9, of the detection area. The upper illumination area 8 of the module 10A_{G} is positioned higher along the main vertical direction 202 compared to the lower illumination area 9 of the module 10B_{G}.

In the device 100_{G}, the main light distribution 131 of the module 10A_{G} and the main light distribution 132 of the module 10B_{G} are arranged so as to illuminate the same area of space, the area embodied by the area of overlap 134 illustrated in FIG. 10 (or as illustrated in FIG. 6), in the vertical direction 2 of the plane 1, that is to say parallel to the main vertical direction 202 of the display screen 200. Such an arrangement makes it possible to localize objects 5 along a vertical direction of space (along y-axis) positioned in an area of space 6 (shown schematically by the axis 6), called left-hand area 6.

In the device 100_{D}, the main light distribution 131 of the module 10A_{D} and the main light distribution 132 of the module 10B_{D} are arranged so as to illuminate another same area of space, the area embodied by another area of overlap 134 (equivalent to the area of overlap 134 illustrated in FIG. 10 or in FIG. 6), in the vertical direction 2 of the plane 1, that is to say parallel to the main vertical direction 202 of the display screen 200. Such an arrangement makes it possible to localize objects 5 along a vertical direction of space (along y-axis) positioned in an area of space 7 (shown schematically on the axis 7), called right-hand area 7. The right-hand area 7 and the left-hand area 6 thus have a different spatial position along the horizontal direction 3 or the main horizontal direction 201 (x-axis).

The main light distribution 131 of the module 10A_{G} is arranged so as to illuminate, in the horizontal direction 3 of the plane 1 or the main horizontal direction 201 of the display screen (along x-axis), at least partially the same area of space (secondary area of overlap numbered 138) as the main light distribution 131 emitted by the illumination module 10A_{D}. Such an arrangement makes it possible to localize objects along a horizontal direction of space (along x-axis) positioned in the upper area 8 (shown schematically on the first main axis A1) of the detection area.

The main light distribution 132 of the module 10B_{G} is arranged so as to illuminate, in the horizontal direction 3 of the plane 1 or the main horizontal direction 201 of the display screen (along x-axis), at least partially the same area of space (other secondary area of overlap 138) as the main light distribution 132 emitted by the illumination module 10B_{D}. Such an arrangement makes it possible to localize objects 5 along a horizontal direction of space (along x-axis) positioned in the lower area 9. The upper area 8 and the lower area 9 thus have a different spatial position along the vertical direction 2 or the main vertical direction 202 (y-axis).

In the example of FIGS. 9, 10 and 11, the module 10A_{G} and the module 10A_{D} are arranged so as to simultaneously emit their emitted beam F, and the modules 10B_{G}, 10B_{D} are arranged so as to simultaneously emit their emitted beam

F, while the illumination modules 10A_{G}, 10B_{G}, and respectively the modules 10A_{D}, 10B_{D}, alternate with one another. Such an arrangement makes it possible to find the three-dimensional position of the object 5.

Indeed, detection of the position of the object in the vertical direction 2 or main vertical direction 202 (y-axis) in the right-hand area 7 and the left-hand area 6 is given:
in the left-hand area 6, by the ratio R_{vertical,6} between the reflected beam from the module 10A_{G} (I_{AG}) and the reflected beam from the module 10B_{G} (I_{BG}), and
in the right-hand area 7, by the ratio R_{vertical,7} between the reflected beam from the module 10A_{D} (I_{AD}) and the reflected beam from the module 10B_{D} (I_{BD}).

As explained in FIG. 2, the two ratios explained above R_{vertical,6} and R_{vertical,7} may each be associated with an angular position w_{vertical} using a conversion table (prerecorded chart). Such ratios make it possible to find the angular position w_{vertical} in the left-hand area 6 and the right-hand area 7 in order to find the spatial position of the object along the vertical direction 2.

Furthermore, it is possible to find the position of the object in the horizontal direction 3 or main horizontal direction 201 (x-axis) in the lower area 8 and upper area 9 by:
in the upper area 8, with a ratio R_{horizontal,8} between the reflected beam from the module 10A_{G} (I_{AG}) and the reflected beam from the module 10A_{D} (I_{AD}), and
in the lower area 9, with a ratio R_{horizontal,9} between the reflected beam from the module 10B_{G} (I_{BG}) and the reflected beam from the module 10B_{D} (I_{BD}).

Such ratios make it possible to find the angular position of the object 5 w_{horizontal} in the upper area 8 and the lower area 9. By way of example, the ratio R_{horizontal,8} in the upper area 8 is obtained using the formula:

$${R}_{h o rizontal , 8} = \frac{{I}_{A G}}{{I}_{A D}} \qquad [ Math 3 ]$$

As explained in FIG. 2, the two ratios explained above R_{horizontal,8} and R_{horizontal,9} may each be associated with an angular position R_{horizontal} using a conversion table (prerecorded chart). Such ratios make it possible to find the angular position w_{horizontal} in the upper area 8 and the lower area 9 in order to find the spatial position of the object along the horizontal direction 3.

According to one variant, another ratio makes it possible to determine the position of the object using the following formula:

$$R = \frac{{I}_{A G} + {I}_{AD}}{{I}_{BG} + {I}_{BD}} \qquad [ Math 4 ]$$

Thus, according to this embodiment, the position of said object 5 is determined based on the various ratios that make it possible to find the polar coordinates of the object 5 using the angle w_{horizontal}, w_{vertical} and the distance T between the object 5 and the detection circuit 20. It is therefore possible, using the angle w_{vertical}, w_{horizontal} and the distance T between the object 5 and the detection circuit 20, to find the three-dimensional Cartesian coordinates.

The present invention is in no way limited to the embodiments described and shown, and a person skilled in the art will know how to add any variant thereto in accordance with the invention.

By way of example, the devices 100_{G} and 100_{D} may form part of the same device 100 consisting of 4 illumination modules 10. The operation of such a system or such a device is similar to the device or system described in the present disclosure.

1. A device for localizing an object, the device comprising:
at least two illumination modules, wherein each illumination module is arranged so as to emit a beam, called emitted beam, in a direction of propagation;
at least one detection circuit arranged so as to receive at least two reflected beams, wherein each reflected beam is associated with a reflection, from said object, of the beam emitted by one of the at least two illumination modules,
wherein said at least two illumination modules and said at least one detection circuit being is positioned in a the same plane;
a computing unit arranged so as to determine the position of said object by analyzing said at least two reflected beams, wherein each beam emitted by one of said at least two illumination modules has a main light distribution obtained by combining at least two secondary light distributions; and
said device furthermore comprising at least one optical component arranged so as to mask a portion of said at least two secondary light distributions, wherein one of said secondary light distributions is arranged so as to be superimposed at least partially on another of said secondary light distributions.

2. The device as claimed in claim 1, wherein the main light distribution emitted by one of said at least two illumination modules is arranged so as to illuminate, in a vertical direction, at least partially a same area of space as at least one other main light distribution emitted by the at least one other of said at least two illumination modules.

3. The device as claimed in claim 1, further comprising at least two other illumination modules positioned on said plane,
wherein said at least one detection circuit is positioned between said at least two illumination modules and said at least two other illumination modules,
wherein the main light distribution emitted by one of said at least two illumination modules is arranged so as to illuminate, in a horizontal direction, at least partially a same area of space as the at least one main light distribution emitted by the at least one other of said at least two other illumination modules.

4. The device as claimed in claim 1, wherein each illumination module comprises at least two distinct light sources, each emitting an initial beam having one of said secondary light distributions.

5. The device as claimed in claim 4, said at least two light sources are aligned along a main axis that is parallel or orthogonal to an axis of said plane.

6. The device as claimed in claim 1,
wherein each illumination module comprises a light source arranged so as to emit an initial beam in a light guide,
wherein said light guide is arranged so as to emit said at least two secondary light distributions.

7. The device as claimed in claim 1,
wherein each main light distribution has a maximum point relative to a maximum light intensity,
wherein each maximum point of the main light distributions is angularly separated by at least ten degrees from a other maximum points of the other main light distributions in a vertical direction.

8. The device as claimed in claim 1, characterized in that
wherein each illumination module comprises an optical axis,
wherein the optical axis of said at least two illumination modules being is inclined with respect to one another at an angle of between 10 and 90 degrees.

9. The device as claimed in claim 1, wherein each secondary light distribution comprises an angular distribution distinct from the angular distribution of the at least one other of said secondary light distributions of the same illumination module.

10. The device as claimed in claim 1, wherein each main light distribution has a total angular extent of between 10 and 90 degrees.

11. The device as claimed in claim 1, characterized in that, wherein in the same illumination module, at least one of said secondary angular distributions has a total angular extent of between 20 and 60 degrees, while the at least one other of said at least two secondary angular distributions has a total angular extent of between 45 and 150 degrees.

12. The device as claimed in claim 1, wherein said at least one optical component is arranged so as to mask at least half of said at least two secondary light distributions of the same illumination module.

13. The device as claimed in claim 1, wherein the at least one optical component is an absorbing element or an optical-beam deflecting element.

14. The device as claimed in claim 1, wherein said at least two illumination modules are arranged on either side of said at least one optical component.

15. The device as claimed in claim 1, wherein the emitted beam is an infrared beam.

16. The device as claimed in claim 1, wherein the beam emitted by each illumination module is a pulsed beam.

17. The device as claimed in claim 16, wherein said pulsed beam contains at least one pulse of at least ten microseconds.

18. The device as claimed in claim 1, wherein said device furthermore comprises a control circuit configured to activate the at least two illumination modules alternately.

19. The device as claimed in claim 1, wherein said at least two illumination modules are arranged symmetrically with respect to an axis of said plane.

20. The device as claimed in claim 1, wherein the position of said object is determined as a function of a chart linking a ratio between an intensity of one of said at least two reflected beams and an intensity of another of said at least two reflected beams with an angular position.

21. A system comprising:
the device as claimed in claim 1; and a display screen arranged so as to extend in two directions, respectively called main vertical direction and main horizontal direction, wherein said at least two illumination modules and said at least one detection circuit are aligned along said main horizontal direction.
